(19) United States
(12) Patent Application Publication
(10) Pub. No.: US 2008/0317258 A1
(43) Pub. Date: Dec. 25, 2008

(54) Integrated cradle and adapter for a portable media player to an auxiliary input of a car stereo

(75) Inventor: Joshua Lindsay, Woodside, CA (US)

Correspondence Address: SignaLogix Inc., 304 Turquoise Street, Milpitas, CA, 95035, US

(73) Assignee: SignaLogix Inc., Milpitas, CA (US)

(21) Appl. No.: 12/139,475

(22) Filed: Jun. 15, 2008

Related U.S. Application Data
(60) Provisional application No. 60/944,795, filed on Jun. 19, 2007.

(51) Int. Cl. H04R 1/02

(52) U.S. Cl. 381/87

(57) ABSTRACT

An adapter for connecting a portable media player to a car stereo that includes an integrated cradle for holding the media player securely and conveniently, and a means for direct connection to a front-mounted auxiliary input receptacle of an automobile stereo system without the need for external cabling.

This application claims the benefit of the following provisional application, which is hereby incorporated by reference in its entirety: U.S. Provisional App. No. 60/944,795, filed on 19 Jun. 2007.

### BACKGROUND OF THE INVENTION

The present invention relates generally to an adapter for use in playing a portable audio/video (media) player device through a car stereo system. More particularly, the invention relates to an integrated adapter that contains a means to directly interface with the auxiliary input jack on the faceplate of an automotive audio and/or video system, and a means to hold the media player securely and in a convenient position for the user to see and reach the controls of the player, i.e. directly on the front of the car stereo faceplate, without the need for external wires.

Recently the popularity of portable digital media players (such as mp3 players) has been growing. A natural progression of these portable devices is to interface them to automobile audio systems to allow the devices to be played in the car. Major automobile manufacturers recently began offering native wired connections to allow popular devices (such as the Apple iPod) to interface directly with the automobile audio system. Native interfaces, while they provide a user interface to control the player through the built-in stereo in the car, are expensive and tend to only support a single family of devices due to proprietary interfaces.

Several other options exist to play a portable media player device through an automobile car stereo, such as Cassette adapters (FIG. 1) and FM transmitters (FIG. 2). Each of these methods has disadvantages. In the case of cassette adapters, fewer cars are being made with cassette decks each year as they are replaced with newer technology. In the case of FM transmitters, limitations on output power are required to avoid interference with radios in nearby cars, rendering the sound quality less than ideal due to interference from broadcast radio stations.

Many car stereo manufacturers and automobile manufacturers have begun including an auxiliary audio input (AUX IN), in the form of a standard 3.5 mm headphone jack 1, on the faceplate of the car stereo 2 (FIG. 3) to allow a portable device 3 to be played through the stereo without utilizing special purpose proprietary connections or radio transmission. This allows for good signal quality to be transmitted from the portable player to the car stereo, and works with any portable media player that uses the standard headphone jack.

Utilizing the AUX IN typically requires a wire 4 to connect from the output of the device 3 to the auxiliary input 1 of the stereo system. The connecting wire 4 is unsightly (FIG. 3), and provides no means to hold the portable device 3, requiring the user to either place the device on the dashboard, center console, seat, or the lap of the user, or to purchase a separate accessory to hold the player.

An additional trend with car stereo manufactures is to include a USB (Universal Serial Bus) pug receptacle on the faceplate. This allows for digital input of media.

Thus a need exists for an integrated cradle and connecting means for use with auxiliary input equipped car stereos.

### SUMMARY OF THE INVENTION

The preferred embodiment of the invention is shown in FIGS. 4, 5 and 6. It comprises a cradle 6 mechanically and electrically suitable for mating with and securely supporting a portable audio/video player, and which also includes an integral audio output plug 6 of the type used for audio headphones. The audio plug may be retractably mounted so as to fold into a recess 9 in the body 10 of the device while the device is being transported or stored.

During use, the audio plug connects directly into a car stereo's auxiliary input 1 without requiring the use of a wire, and provides the mechanical mounting means to hold the cradle 6 and portable media player 3, by plugging the output plug 6 directly into the AUX IN jack 1 on the stereo 13, as shown in FIG. 6.

### BRIEF DESCRIPTION OF THE DRAWINGS

FIG. 1 shows two popular versions of cassette adapters for use in playing portable audio players through car stereos. The player may attach either through a standard headphone jack or a custom dock connector, and play audio through a magnetic recording head which couples magnetically with the playback head in the car's cassette deck.

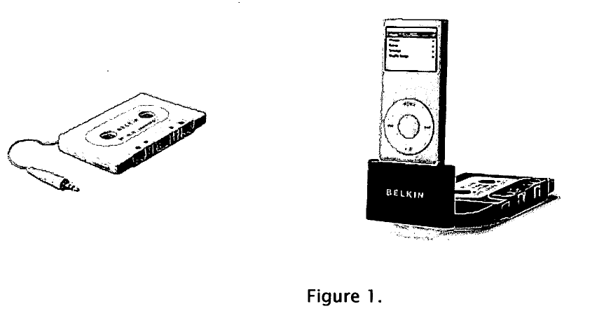

FIG. 2 shows a typical FM transmitter adapter used for playing a portable media player through the FM radio in a car. The display shows the FM frequency over which the audio signal is being transmitted. The user chooses a frequency on the transmitter that is unused in the local area, and tunes the FM radio receiver in the car to match the transmission frequency.

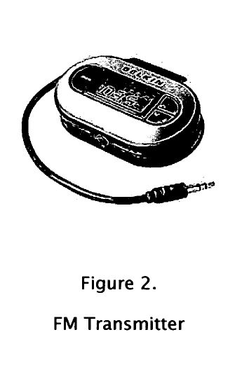

FIG. 3 shows a car stereo 1 which is equipped with an auxiliary audio input 2 on the faceplate of the stereo, in the form of a standard 3.5 mm headphone jack, with a portable media player 3 plugged into it through a cable 4.

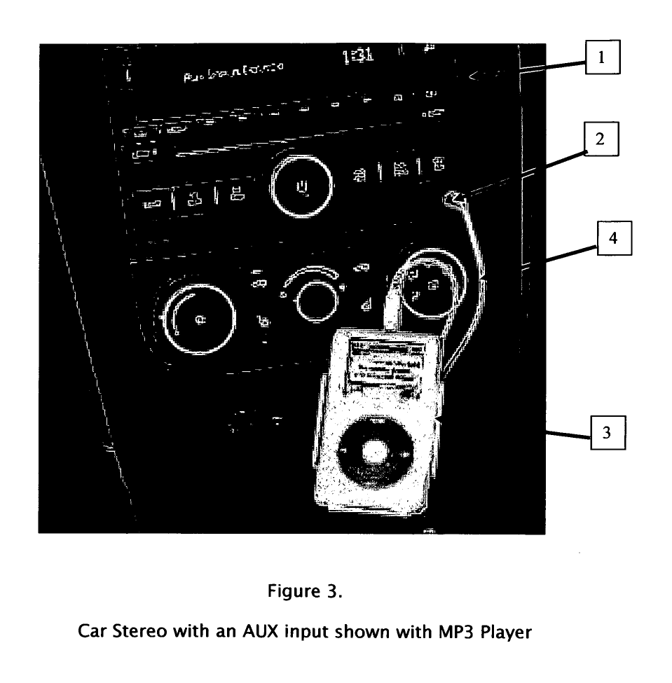

FIG. 4 shows one embodiment of the invention, including a cradle 5 for holding the portable media player, a plug 6 for connecting into the AUX IN of the stereo, a means for plugging into the audio out jack of the portable player, shown in this figure as another audio jack 7, but which could also comprise a proprietary dock connector for specific models of media player.

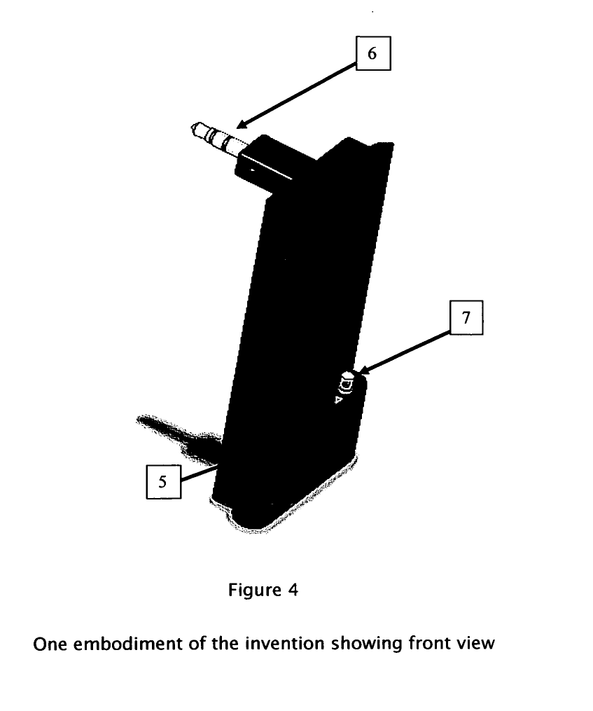

FIG. 5 shows the rear view of this same embodiment of the present invention, showing the headphone plug 6 audio output, mounted on a pivot 8 which allows the plug to retract into a cavity 9 in the body 10 of the device.

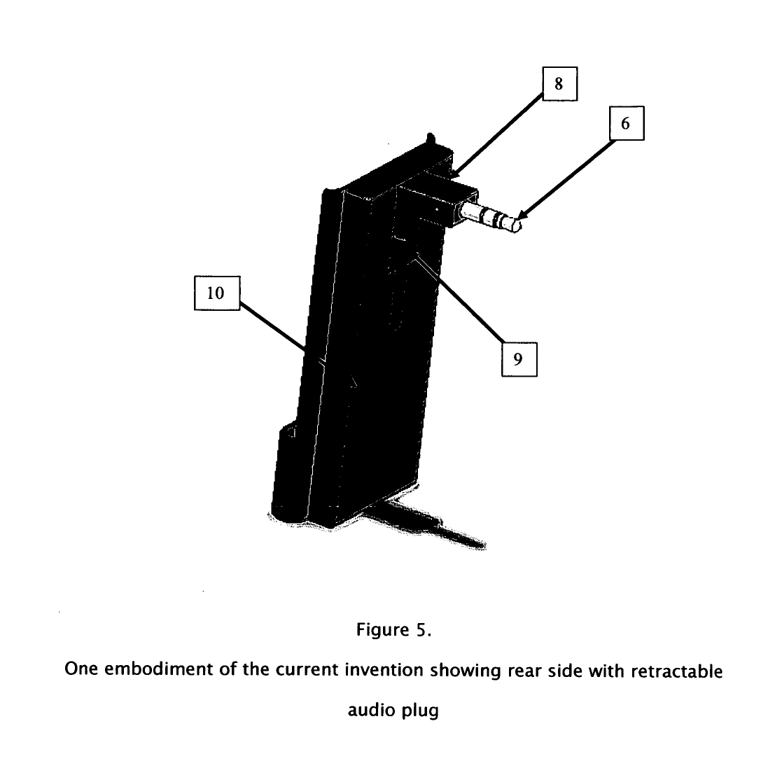

FIG. 6 shows the device 11 with portable media player 12 aligned to be inserted into the auxiliary input 1 of a car stereo 13.

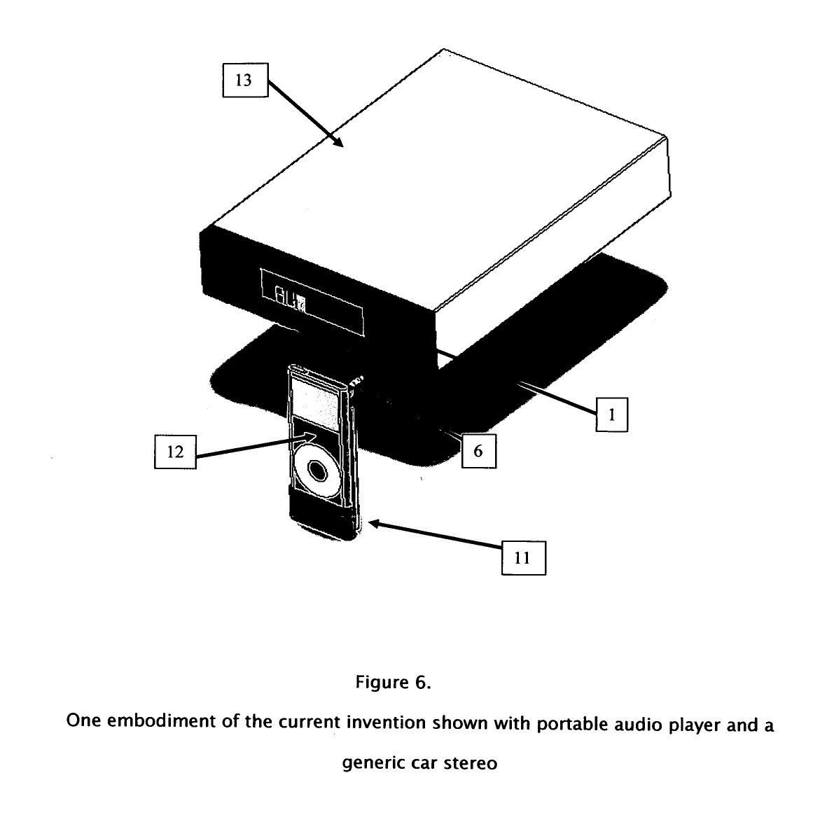

What is claimed is:

1. An adapter for enabling signals produced by a signal source to be reproduced as audio sounds by an audio system, the adapter comprising:
A housing having-an integral output connector which mates with an auxiliary input connector on the audio system;
A cradle for mounting the signal source to the adapter;
A means for electrically coupling the signal source and the output connector.

2. The adapter of claim 1, wherein the auxiliary input connector of the audio system comprises the mechanical mounting for the adapter and signal source.

3. The adapter of claim 1, wherein the holder comprises a connector for coupling with a headphone connector on the signal source.

4. The adapter of claim 1, wherein the holder comprises a connector for coupling with a docking connector on the signal source.

5. The adapter of claim 2, wherein the holder further comprises an opening for an auxiliary power element for charging the signal source while mounted to the adapter.

6. The adapter of claim 3, wherein the holder is movably connected to the output connector such that the signal source can be viewed and operated from different angles.

7. The adapter of claim 4, wherein the output connector is movably connected to the housing such that the connector may be retracted into the body of the housing for portability and storage.

8. The adapter of claim 1, wherein the signal source is a portable audio device.

9. The adapter of claim 1, wherein the signal source is a cell phone type device.

10. The adapter of claim 1, wherein the signal source is a PDA (personal digital assistant) type device.

11. The adapter of claim 1, wherein the signal source is a radio receiver.

12. The adapter of claim 1, wherein the signal source is a Satelite radio receiver.

13. The adapter of claim 1, wherein the signal conveyance is analog.

14. The adapter of claim 1, wherein the signal conveyance is digital.
